(19) United States
(12) Patent Application Publication
(10) Pub. No.: US 2026/0109040 A1
(43) Pub. Date: Apr. 23, 2026

(54) SYSTEM

(71) Applicant: SOFTBANK GROUP CORP., Tokyo (JP)

(72) Inventor: Tatsuya UCHIBORI, Tokyo (JP)

(73) Assignee: SOFTBANK GROUP CORP., Tokyo (JP)

(21) Appl. No.: 19/357,442

(22) Filed: Oct. 14, 2025

(30) Foreign Application Priority Data
Oct. 17, 2024 (JP) 2024-181657

(51) Int. Cl. B25J 9/16

(52) U.S. Cl. CPC B25J 9/1676; B25J 9/161

(57) ABSTRACT

A system includes a processor that is configured to collect real-time data from a robot, preprocess the collected data, predict future behavior of the robot using the preprocessed data, perform risk assessment based on the predicted behavior, generate an alert based on the result of the risk assessment, and notify a user of the generated alert.

### CROSS-REFERENCE TO RELATED APPLICATION

This application is based on and claims priority under 35 USC 119 from Japanese Patent Application No. 2024-181657 filed on October 17, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventionally, there has been a lack of effective systems to predict the future behavior of robots in real time, quantitatively assess risk based on such predictions, and promptly communicate potential hazards to users. Industrial environments in particular face increasing safety and operational concerns as robots and humans collaborate in shared spaces. Existing solutions often fail to process real-time data, miss abnormal or unsafe actions, or do not provide actionable alerts to users in a timely manner.

### SUMMARY

The present invention provides a system comprising a processor that collects real-time data from a robot, preprocesses the collected data, predicts the robot's future behavior using the preprocessed data, performs a risk assessment based on the predicted behavior, generates an alert if the predicted behavior is determined to present a risk, and notifies the user of the generated alert. Time-series data is used for accurate prediction of future behavior, and a risk score is calculated when the predicted behavior exceeds safety standards, thereby allowing prompt user response to mitigate potential dangers.

“real-time data” means data obtained from the robot continuously or at short, regular intervals, reflecting the immediate status or conditions of the robot and its environment.

“preprocess” means the raw data collected from the robot is cleaned, transformed, normalized, or otherwise conditioned to be suitable for further analysis or input into predictive models.

“predicts future behavior” means the processor estimates or forecasts the likely actions, movements, or operations of the robot in advance based on the preprocessed data.

“risk assessment” means the processor evaluates the predicted future behavior of the robot for potential hazards or unsafe situations according to predetermined criteria or safety standards.

“alert” means a notification or warning message is generated to inform the user of a detected or predicted risk related to the robot’s behavior.

“notifies a user” means the generated alert is communicated or presented to a human operator or user via a terminal, display, or other notification method.

“time-series data” means a sequence of data points is collected or organized in chronological order, allowing analysis of trends and patterns over time.

“risk score” means a numerical value is assigned, indicating the level or probability of risk associated with the predicted behavior of the robot.

“safety standard” means a predetermined threshold or rule is used to define safe operational boundaries or acceptable risk levels for the robot’s actions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

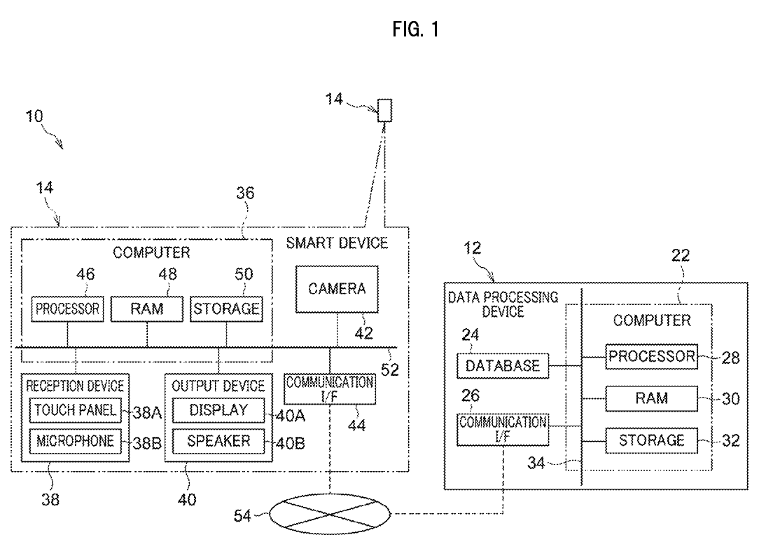

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

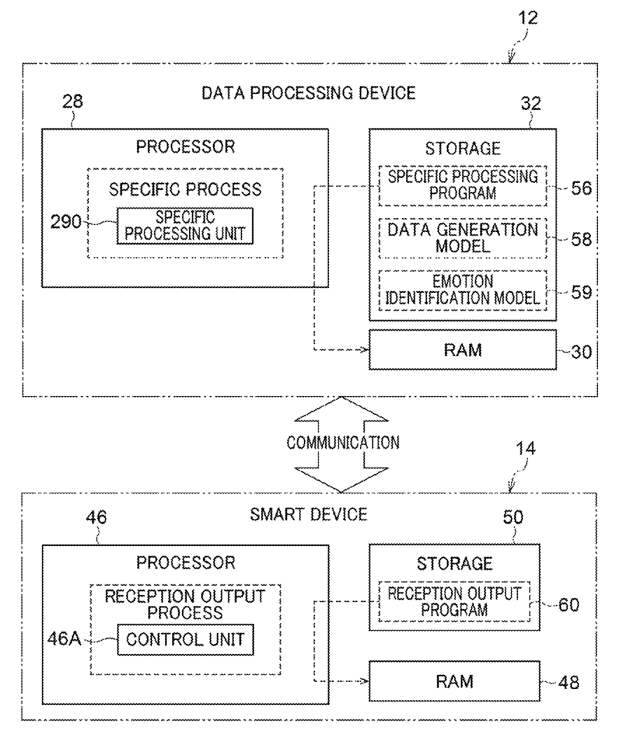

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for monitoring and controlling machine devices such as robots face challenges in accurately predicting future operations in real time and promptly evaluating associated risks. Due to limitations in processing time-series data and the inability to utilize advanced artificial intelligence techniques, these systems often fail to provide timely and precise risk alerts to users, thereby compromising safety and operational efficiency. There is a need for a system that can leverage generative artificial intelligence to improve the accuracy of future behavior prediction and enable rapid risk assessment and alert notification to users.

The specific processing by the specific processing unit 290 of the data processing device 12 in Example 1 is realized by the following means.

The present invention provides a server comprising a processor configured to collect real-time, time-series operation information from a machine device, preprocess the collected information, input preprocessed data into a generative artificial intelligence model to predict future operations, generate prompt sentences to enhance prediction accuracy, evaluate risk by comparing predicted operations with safety standards to calculate risk scores, generate alert notifications when risk scores exceed a threshold, and notify users of the alerts via a display device. This enables more accurate prediction of machine device behaviors, rapid risk assessment based on advanced AI models, and timely notification to users to ensure safety and efficiency in operational environments.

The term “processor” refers to a hardware or software component that executes instructions to process data and control operations within a system.

The term “machine device” refers to an apparatus, including but not limited to robots, equipped with sensors and actuators, capable of performing mechanical or electronic operations.

The term “operation information” refers to data indicating the state, movement, or activity of a machine device, collected over time.

The term “time series” refers to a sequence of data points that are indexed or organized according to time order.

The term “preprocessing” refers to procedures applied to raw data, such as noise removal, normalization, and data formatting, to prepare it for subsequent analysis.

The term “generative artificial intelligence model” refers to a type of artificial intelligence algorithm or system capable of creating output, such as predictions, by learning patterns from input data.

The term “prompt sentence” refers to a text input formulated to guide or instruct a generative artificial intelligence model regarding the content or focus of its output.

The term “future operations” refers to predicted actions, behaviors, or states of a machine device based on current and historical operation information.

The term “risk score” refers to a numerical value indicating the degree of risk associated with a predicted future operation when compared to predetermined safety standards.

The term “alert notification” refers to a message generated by the system to inform users of a detected risk, including the associated information and recommended actions.

The term “display device” refers to any interface, such as a screen or panel, capable of presenting information or alerts to a user.

The term “user” refers to an individual who receives, observes, and may react to alert notifications regarding the operation of a machine device.

An embodiment of the present invention is described below, based on the scope of the claims.

The system comprises a server equipped with a processor, one or more machine devices such as industrial robots with various sensors, multiple user terminals, and a display device for alert notifications. The server may be implemented using general-purpose computing hardware, such as a workstation or server machine operating on a platform like Linux. The processor operates software components, including a database (for example, PostgreSQL), a programming environment such as Python, data analysis libraries like Pandas and Numpy, and a generative artificial intelligence model built on platforms such as PyTorch or TensorFlow.

The server is designed to collect real-time operation information from machine devices using standard communication protocols such as MQTT or HTTP. For example, a robot may send periodic updates containing information such as position, speed, sensor readings (e.g., temperature and environmental status), and operation state. The server receives this data and stores it sequentially in a time-series database for later processing and analysis.

The server performs preprocessing on the collected data. This involves removing noise, correcting anomalies, filling missing data, and normalizing the values to a consistent scale. Such preprocessing ensures that the input to the generative artificial intelligence model is clean and formatted appropriately. These procedures can be implemented using software libraries such as Pandas for data manipulation and Numpy for computational efficiency.

After preprocessing, the server generates a suitable prompt sentence to instruct the generative AI model for prediction tasks. The generative AI model receives the cleaned, time-series operation information and the generated prompt sentence as input, and generates predicted future operations of the machine devices. The model may be a trained long short-term memory (LSTM) neural network or a Transformer-based architecture for time-series forecasting within frameworks such as PyTorch or TensorFlow.

For example, a possible prompt sentence provided to the generative AI model is:

"Analyze the time-series data from the factory machine's operation sensors and predict any abnormal or dangerous behavior patterns for the next 10 minutes."

The server then evaluates the generated prediction by comparing the predicted future operations with predetermined safety standards. The evaluation is implemented in software running on the server, which calculates a risk score for each predicted scenario. If the risk score for any scenario exceeds a preset threshold, the server generates an alert notification containing details regarding the risk, affected device, expected timing, and recommended user actions.

Subsequently, the server transmits the alert notification to the user terminals via a communication network. The terminal, such as a smartphone, tablet, or industrial display, receives the alert and presents it to the user using visual or audio means. The display device shows the risk information clearly, prompting the user to take immediate action as necessary.

For example, in a use case within a factory, the system predicts that a robot's movement will enter a human-occupied area within a few minutes. The alert sent to the terminal may state: "Warning: The robot is projected to enter a restricted area. Please halt the machine or evacuate the vicinity immediately."

Users interact with the system through the terminals, acknowledging alerts and executing the recommended procedures, such as remotely stopping a device or moving personnel out of a hazardous area. This embodiment ensures accurate prediction, efficient risk assessment, and timely notification to maintain operational safety and productivity.

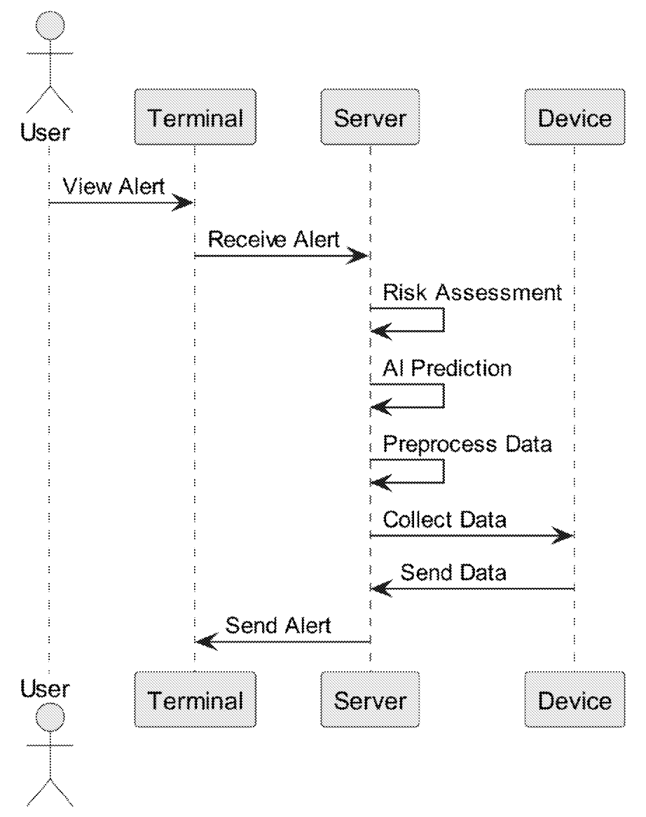

The following describes the processing flow using FIG. 11.

### Step 1:

The server receives real-time operation information from machine devices, such as robots, via a network communication protocol. The input is a stream of sensor data packets including time stamps, position data, motion state, and various environmental measurements. The server processes the incoming data by parsing the packets and saving them sequentially into a time-series database. The output is a structured dataset stored and available for further analysis.

### Step 2:

The server retrieves raw operation information from the database and initiates preprocessing. The input is unprocessed time-series data, which may contain noise, missing values, or irregular intervals. The server applies data cleaning techniques such as noise filtering, missing data interpolation, and normalization using Python libraries like Pandas and Numpy. The output is a clean, consistent time-series dataset that is formatted for use in AI-based prediction.

### Step 3:

The server generates a prompt sentence to instruct the generative AI model for prediction tasks. The input is the description of the context, such as the machine device type and operational goals. The server creates a natural language prompt sentence, for example: "Analyze the robot’s operational data and predict any anomalous behavior for the next 10 minutes." The output is the tailored prompt sentence.

### Step 4:

The server inputs both the preprocessed time-series data and the generated prompt sentence to the generative AI model, implemented in frameworks like PyTorch or TensorFlow. The input consists of the clean dataset and the prompt sentence. The server runs the AI model, which analyzes historical patterns and creates a forecast of the machine device’s future operations over a defined period. The output is a set of prediction results showing the most probable future behaviors.

### Step 5:

The server evaluates the prediction results by comparing them with pre-established safety standards. The input is the predicted future operations from the AI model. The server executes a risk assessment algorithm, calculating a risk score for each identified scenario and detecting if any scenario exceeds the safety threshold. The output is the risk evaluation, including detailed risk scores and scenario identifiers.

### Step 6:

The server generates an alert notification if the risk assessment indicates a scenario that exceeds the safety threshold. The input is the risk evaluation with associated scores and predicted risks. The server prepares an alert by formatting the notification message to include risk details, timing, affected device, and recommended user actions. The output is a finalized alert message ready for transmission.

### Step 7:

The terminal receives the alert notification from the server. The input is the alert message transmitted over the communication network. The terminal displays the alert information to the user, using visual cues such as flashing graphics or audio signals to ensure immediate attention. The output is the clear presentation of risk information and recommendations to the user.

### Step 8:

The user observes the alert on the terminal and responds accordingly. The input is the notification presented by the terminal. The user takes action, such as pressing a stop button, evacuating an area, or acknowledging the alert. The output is a user response that either mitigates the detected risk or confirms acknowledgment of the safety measure.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In current industrial environments, it is difficult to monitor the real-time operations of machinery and to accurately predict potential hazardous behavior in advance. Conventional systems often lack the ability to analyze complex time-series data, assess risks using advanced artificial intelligence models, and effectively notify operators in a manner that is adapted to the operator’s emotional state. As a result, there are shortcomings in both the safety and efficiency of industrial operations, including delays in responding to urgent risks, insufficient guidance on optimal responses, and a lack of personalized alerts based on user state.

The specific processing by the specific processing unit 290 of the data processing device 12 in Application Example 1 is realized by the following means.

The present invention provides a server comprising a processor configured to collect real-time time-series operational data from industrial equipment, preprocess the data using noise reduction and normalization, utilize a trained generative artificial intelligence model to predict multiple possible future operational states and their associated risk levels, generate and transmit detailed alerts and recommended responses to an information processing terminal, analyze operator voice or image data to estimate emotional state using an emotion recognition model, and adapt the alert content and delivery method accordingly. This enables more timely and accurate risk detection, personalized guidance and notification to operators, and continuous feedback for safer and more efficient operation of industrial machinery.

The term “industrial machinery equipment” refers to automated devices or systems used in manufacturing or production environments that are capable of performing physical tasks, including but not limited to robots, conveyors, and automated guided vehicles.

The term “real-time data” refers to information that is captured, processed, and made available with minimal delay from the time of its original generation, enabling immediate analysis and response.

The term “time-series operational information” refers to a sequence of data points collected in chronological order that represents changes in the state, position, or operation of industrial machinery equipment over time.

The term “preprocess” refers to processing raw collected data to remove noise, standardize numerical values, and format the data in a way that is suitable for input into an artificial intelligence model.

The term “generative artificial intelligence model” refers to a machine learning model that can generate predictive data outputs, such as future operational states or behaviors, based on the analysis of historical and current input data.

The term “risk score” refers to a numerical value representing the probability or severity of a hazardous event or unsafe behavior, calculated from the predicted future operational states and relevant safety standards.

The term “risk assessment” refers to the process of evaluating predicted future operational behaviors against predefined safety criteria to determine the likelihood and potential impact of hazardous situations.

The term “alert information” refers to a structured data message that includes details of a detected risk, the recommended operator response, and associated instructions intended to inform and guide the operator.

The term “information processing terminal” refers to an electronic device, such as a smartphone, tablet, or workstation, capable of receiving notifications, processing data, and interfacing with an operator.

The term “emotion recognition model” refers to an artificial intelligence model designed to analyze voice data, image data, or other biometric data to determine an operator’s current emotional state.

The term “operator’s emotional state” refers to the psychological or affective condition of the person interacting with the industrial machinery equipment, such as calmness, anxiety, or distress.

An embodiment for implementing the invention will now be described in detail.

The system includes at least one server comprising a processor, at least one information processing terminal, and industrial machinery equipment such as robots or automated guided vehicles deployed at a factory or manufacturing site. The server and terminal communicate with each other and the industrial machinery equipment via a communication network such as Ethernet or wireless LAN.

The server is equipped with a database system, such as a relational database management system, to store and manage time-series operational information received from the industrial machinery equipment. The server uses hardware such as a general-purpose or dedicated computing device, and may utilize a graphics processing unit (GPU) or tensor processing unit (TPU) to accelerate artificial intelligence model computation. The terminal may be a smartphone, tablet, or workstation capable of running a dedicated user interface application and capturing sensory data such as images and audio.

The server receives real-time data from the industrial machinery equipment, which includes but is not limited to, position data, velocity, machine state, environmental sensor data, images, and audio. The server preprocesses the data by applying noise reduction methods such as moving average or low-pass filtering and standardizing the input data range between 0 and 1. Software frameworks such as TensorFlow or PyTorch are used for data preprocessing, normalization, and subsequent neural network computations.

The server inputs the preprocessed time-series operational information into a trained generative AI model, such as an LSTM or Transformer model implemented in TensorFlow or PyTorch. The generative AI model outputs predictions of multiple possible operational trajectories and probability values for each predicted scenario over a specified future timeframe.

The server performs risk assessment by comparing the predicted operational patterns with stored parameters that represent safety standards. The server uses custom algorithms or pre-set thresholds to calculate a risk score for each predicted pattern. If any risk score exceeds a predetermined threshold, the server generates alert information detailing the risk, the predicted time to incident, and recommended operator actions.

The server sends the alert information as a notification to the information processing terminal. The terminal application receives the alert, displays both textual and visual information (such as area maps or highlighted machinery icons), and can play an acoustic alarm or vibrate to attract the user’s attention.

The information processing terminal, using its integrated camera and microphone, acquires biometric data such as the operator’s voice or facial image in response to or during the alert period. The terminal applies an emotion recognition model, which may be implemented using TensorFlow Lite or called as a cloud-based API, to analyze the operator’s emotional state. The terminal then transmits the estimated emotional state to the server.

Upon receiving the emotional state, the server adapts the alert message content or notification delivery format to the operator’s condition by providing more detailed explanations and reassuring language if stress is detected.

The operator can interact with the terminal to acknowledge alerts, request additional guidance, or initiate machine response actions such as emergency stopping of equipment. The system records operator responses and can provide feedback to the control systems of the industrial machinery equipment for further automated adjustment or shutdown.

As a concrete example, if a robot unexpectedly accelerates towards a restricted area, the server would detect the abnormality, predict the robot’s entry into the restricted zone using the generative AI model, assess the risk score as high, generate an urgent alert, adapt its presentation if user anxiety is detected, and send it to the terminal for immediate operator action.

An example of a prompt sentence for controlling the behavior of the generative AI model is as follows:

“Given the last 60 seconds of position, velocity, and sensor time-series data for this factory robot, predict the most likely trajectory and identify any patterns that require urgent safety intervention.”

This embodiment provides a concrete and reproducible way of constructing, operating, and applying the claimed invention using known computation, communication, and artificial intelligence technologies.

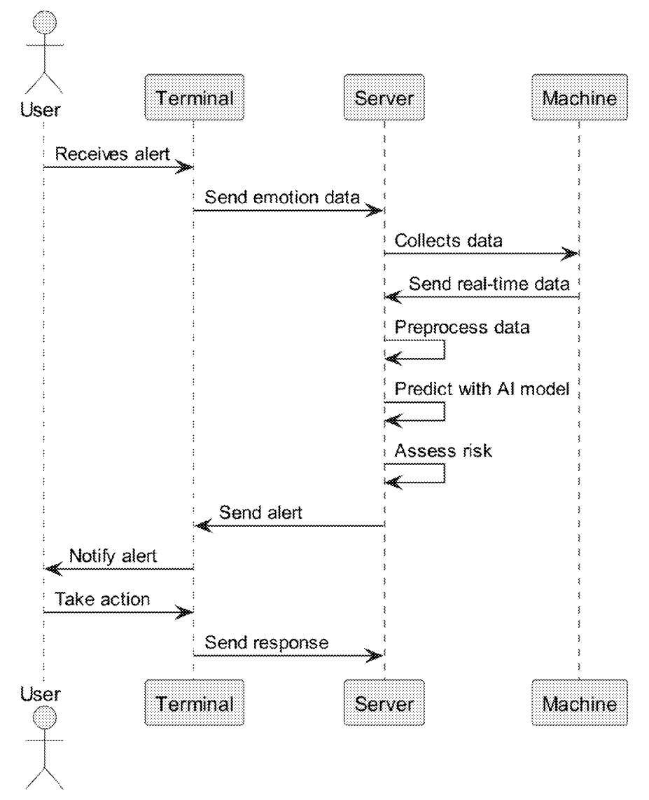

The following describes the processing flow using FIG. 12.

### Step 1:

The server receives real-time time-series operational data as input from multiple industrial machinery devices using a network protocol such as MQTT or HTTP. The server collects incoming data packets which include information such as position, velocity, machine state, and sensor values. The output of this step is the storage of raw data with timestamps into a structured relational database for later processing.

### Step 2:

The server preprocesses the collected raw data as input by performing noise reduction, outlier removal, and data normalization routines using a machine learning framework such as TensorFlow. Specifically, the server applies algorithms like moving average filtering to smooth the position data and scales numeric values to a uniform range. The output of this step is a clean, normalized, and structured time-series dataset for each device, stored in memory or temporary storage.

### Step 3:

The server inputs the preprocessed time-series dataset and an appropriate prompt sentence into a trained generative AI model, which may be implemented as an LSTM or Transformer neural network in TensorFlow or PyTorch. The server executes the model inference, and the generative AI model processes the data and outputs predictions of possible future operational states, including predicted trajectories and probability distributions for each scenario.

### Step 4:

The server takes the output predictions from the generative AI model as input and compares each predicted operational state with predefined safety criteria retrieved from a database. The server performs calculations, such as checking for potential collisions or violation of safety zones, and computes a risk score for each scenario. The output of this step is an annotated list of predicted scenarios, each with an associated risk score and further classification as high-risk or low-risk.

### Step 5:

The server evaluates the annotated scenarios and, when a predicted risk score exceeds a predefined threshold, generates alert information as output. This alert includes details of the risk, the involved device, the predicted time to incident, and specific recommended actions. The server serializes the alert into a suitable format (such as JSON) and transmits it to the terminal using a messaging protocol like Firebase Cloud Messaging.

### Step 6:

The terminal receives the alert information as input from the server. The terminal application processes this input, displays the alert visually and acoustically on the user interface, and provides the operator with options to acknowledge or escalate the alert. The output is an immediate notification to the operator and a log entry of the alert presentation.

### Step 7:

The terminal, with permission, activates its camera and microphone to capture the operator’s facial image or voice as input when an alert is presented. The terminal processes this biometric data using an emotion recognition model, such as TensorFlow Lite or a cloud API, to estimate the operator’s emotional state. The output of this step is a status update sent to the server containing the detected emotional state.

### Step 8:

The server receives the operator’s emotional state as input and processes it together with the current alert information. If the operator is estimated to be anxious or distressed, the server modifies the content or delivery of future alerts to include more explanatory or reassuring language. The output is a dynamically adjusted alert or notification style that is sensitive to the operator’s condition.

### Step 9:

The user, upon receiving the alert and guidance on the terminal, takes action based on the recommended instructions. The user may acknowledge the alert in the application, request further support, or initiate a direct intervention such as stopping machinery. The output of this step is an action log sent from the terminal to the server, and potentially a command sent to the industrial machinery equipment for immediate safety response.

### Step 10:

The server, terminal, and user continuously repeat Steps 1 to 9, providing ongoing monitoring, prediction, alerting, emotional response adaptation, and action logging to maintain real-time situational awareness and enhance factory safety and efficiency. The output is a persistent state of improved operational hazard detection, alert generation, and human-machine collaborative intervention.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In operation environments where robots interact with humans, it is difficult to provide real-time risk assessment and adaptive feedback that takes into account the emotional state of the user. Existing systems tend to deliver one-sided warnings without considering the user's emotions, resulting in reduced user assurance and potentially compromised safety. Furthermore, conventional solutions often lack the capability to predict future robot actions based on time-series data and to personalize alerts according to real-time biometric and emotional data from users.

The specific processing by the specific processing unit 290 of the data processing device 12 in Example 2 is realized by the following means.

The present invention provides a server comprising a processor configured to collect time-series information from an operation device, preprocess the collected information, input the preprocessed data into a generative information processing model to estimate future actions of the operation device, compare the estimated actions with environmental information and safety standards to calculate a risk level indicator, generate and adjust alerts based on user biometric and emotional state information, and notify these alerts to a display device. This enables real-time risk prediction and user-adaptive alert generation, improving both operational safety and user experience by accounting for the user's emotional state in the notification process.

The term “processor” refers to a hardware-implemented device or computing unit capable of executing programmed instructions to perform data processing and control functions within a system.

The term “operation device” refers to a functional apparatus, such as a robot or automated machine, which performs mechanical or electronic operations and can generate operational data.

The term “present information” refers to real-time or current data, including parameters such as position, status, sensor readings, and other measurable variables obtained from the operation device.

The term “time-series information” refers to a sequence of data points collected or recorded at successive time intervals, representing the change of one or more variables of the operation device over time.

The term “preprocessing” refers to data operations performed on collected information, including noise removal, missing value completion, and format conversion, to prepare the data for subsequent analysis.

The term “generative information processing model” refers to a computational model, such as a generative artificial intelligence model, capable of generating predictions or simulations based on input data, including the estimation of future actions of an operation device.

The term “future actions” refers to the predicted and estimated subsequent behaviors, states, or movements of the operation device based on analysis of collected time-series data.

The term “environmental information” refers to data representing conditions or characteristics external to the operation device, such as spatial arrangement, presence of obstacles, temperature, and other factors relevant to operational safety.

The term “predetermined safety standards” refers to pre-established rules, thresholds, or criteria used as benchmarks to evaluate the safety of operation device behavior.

The term “risk level indicator” refers to a quantitative or qualitative value, computed by the processor, that represents the degree of risk associated with the predicted future actions of the operation device.

The term “alert” refers to a notification message, including textual, visual, or auditory information, generated by the system to warn the user of a potential risk or to prompt necessary action.

The term “user biometric information” refers to data derived from the user's biological or physiological characteristics, such as facial images, voice features, or other measurements, used to assess user state.

The term “user emotional state” refers to an assessment or classification of the user's feelings, attitudes, or psychological disposition, as inferred from biometric information or behavioral cues.

The term “display device” refers to an interface apparatus, such as a screen, monitor, or speaker, capable of presenting alerts or information to the user in a perceivable manner.

One embodiment of the present invention is implemented as a system consisting of a server, at least one terminal device, and at least one operation device, such as a robot, with the server comprising a processor configured to perform a series of data acquisition, processing, prediction, risk evaluation, alert generation, and user-adaptive notification procedures.

The server is equipped with standard computer hardware, such as a central processing unit, random access memory, storage unit (for example, a hard drive or SSD), and a network interface. The server operates on a widely-used operating system, such as Linux (e.g., Ubuntu). The server is also connected to a database system, such as PostgreSQL or MySQL, for storing incoming data.

The operation device, for example a robot, is equipped with various sensors such as position sensors, accelerometers, temperature sensors, and environmental sensors, capable of continuously measuring and transmitting data over a network to the server in real time.

The terminal, which functions as a user interface, may be a general-purpose smart device such as a tablet, laptop, or desktop computer, equipped with a display, speaker, camera, and microphone. The terminal is configured to receive alerts from the server, present visual and/or audio feedback to the user, and capture real-time biometric information, such as facial images or voice data.

The server is programmed to collect present information, including time-series data, from the operation device through the network. For data preprocessing, the server uses software such as Python, with libraries including Pandas and NumPy to remove noise, fill in missing values, and format the sensor data. The preprocessed time-series information is then normalized and formatted as an appropriate input for a generative AI model, which can be implemented using frameworks such as PyTorch or TensorFlow.

The generative AI model, resident on the server or on a dedicated machine connected to the server, is designed to predict the future behavior of the operation device based on the incoming time-series data. The server builds a prompt sentence for this model, such as:

"Given the last 60 seconds of robot sensor data, predict the robot’s movement path for the next 10 seconds."

On receiving a prediction from the AI model, the server compares the predicted future actions with predefined environmental information and safety standards, which are stored in the database. The server calculates a risk level indicator, typically as a numerical risk score reflecting the likelihood and severity of potential safety violations.

If the risk level indicator exceeds a predetermined threshold, the server generates an alert message. The alert message is dynamically adjusted according to the user’s current biometric and emotional state, which is estimated by analyzing image and audio information received from the terminal using an emotion analysis engine, such as a convolutional neural network, the Affectiva SDK, or an equivalent software module.

For example, if a user is determined to be anxious or surprised, the alert output by the server includes additional reassuring content, such as:

"The robot is under strict control and will stop if necessary. Please remain calm."

If the user’s emotional state is neutral, a more standard warning may be displayed.

The terminal device presents the adjusted alert message using visual and/or auditory outputs. For audio outputs, the terminal may use a text-to-speech engine, such as Amazon Polly or a standard operating system speech API, to verbally deliver the alert.

A sample prompt sentence used by the generative AI model is:

"Tell me a method to predict the robot's next behavior and generate an adaptive warning based on the user's emotional state."

In this embodiment, the server, terminal, and operation device operate in coordination to ensure real-time risk prediction and user-adaptive notification, improving both safety and the user experience by integrating generative AI modeling and emotion-based alert customization.

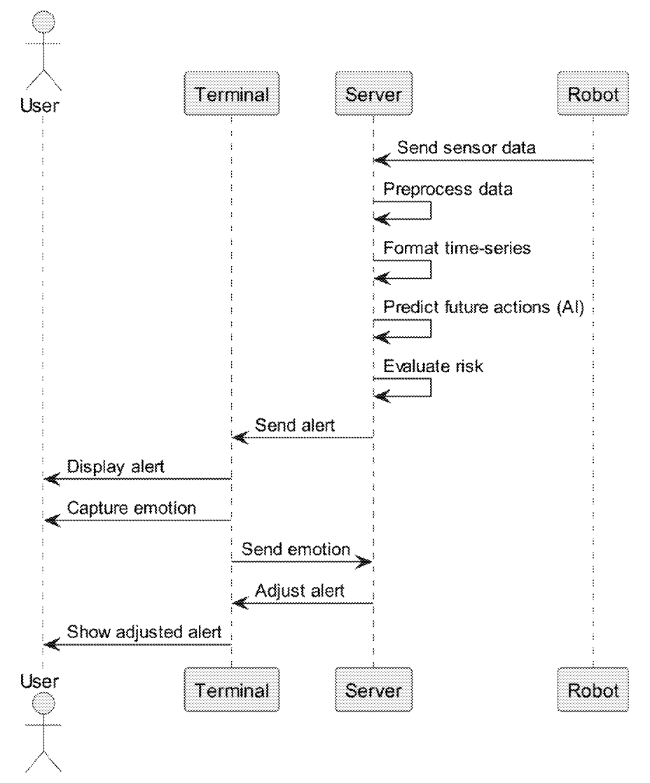

The following describes the processing flow using FIG. 13.

### Step 1:

The server collects real-time sensor data from the operation device, such as a robot, via a network connection. The input is a data stream from various robot sensors, including position, speed, temperature, and environmental values. The server receives and temporarily stores these raw sensor data packets in a structured database. The output is a set of stored time-stamped sensor data records ready for further processing.

### Step 2:

The server performs data preprocessing using software tools (e.g., Python with Pandas and NumPy). The input is the raw sensor data retrieved from the database. The server removes any outlier or anomalous values, fills in missing data points with interpolation, and applies format conversion (such as normalizing data). The output is a clean, continuous, and standardized time-series dataset suitable for machine learning input.

### Step 3:

The server structures the preprocessed data into a fixed-length time-series window, such as the most recent 60 seconds of data. The input is the cleaned time-series dataset. The server reshapes and normalizes the data to form an array that matches the input requirements of the generative AI model. The output is an input-ready time-series data array.

### Step 4:

The server submits the formatted time-series data to a generative AI model implemented in a framework such as PyTorch or TensorFlow. The input is the normalized time-series data array. The server also builds a prompt sentence, for example: "Given the last 60 seconds of robot sensor data, predict the robot’s movement path for the next 10 seconds." The AI model processes the input and predicts the robot’s future trajectory as a sequence of positions or actions. The output is a predicted series of robot actions for the next period.

### Step 5:

The server evaluates the risk of the predicted robot actions by comparing them to predefined environmental data and safety standards. The input is the predicted future trajectory and stored safety criteria. The server checks for possible conflicts, such as collisions with obstacles or safety violations, and calculates a risk score. The output is a risk level indicator and additional risk information.

### Step 6:

The server generates an alert if the risk indicator exceeds a predetermined threshold. The input is the calculated risk score and information about the risk (such as location and severity). The server composes a warning message, including recommended actions and estimated timing. The output is a warning notification prepared for delivery to the terminal.

### Step 7:

The terminal receives the warning message from the server and immediately activates its camera and microphone to capture the user’s facial expression and voice. The input is the user’s image and audio data. The terminal processes this data using an emotion analysis engine, such as a convolutional neural network or affective computing SDK, to infer the user’s emotional state. The output is an emotion label such as "anxious," "neutral," or "calm."

### Step 8:

The server receives the emotion label from the terminal and adapts the warning content and presentation accordingly. The input is the user’s emotional state and the original warning message. The server adjusts the text or adds reassurance if required by the user’s emotional state. The output is a finalized alert message customized for the user.

### Step 9:

The terminal displays the customized alert message to the user, both visually on the screen and, if appropriate, by audio using a text-to-speech engine. The input is the user-specific alert message from the server. The terminal outputs the alert as a pop-up notification and/or a spoken message for the user to hear or see, ensuring timely and appropriately tailored risk communication.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional autonomous apparatus systems, the actions of the autonomous apparatus, such as a robot, are not sufficiently adjusted according to the emotional state of the user, resulting in inadequate improvement in user satisfaction and seamless interaction. Particularly in environments with frequent user contact, such as commercial facilities or service locations, it is difficult to provide prompt and appropriate responses to negative user emotions such as confusion or anxiety. Furthermore, conventional systems lack mechanisms for dynamically analyzing user emotions in real time, assessing risks of predicted apparatus actions, and optimizing user notifications using advanced language generation technologies.

The specific processing by the specific processing unit 290 of the data processing device 12 in Application Example 2 is realized by the following means.

The present invention provides a server comprising a processor configured to acquire operational status information from an autonomous control apparatus, execute information conversion processing, estimate the apparatus's future operation, perform risk evaluation, generate alert information, notify a user, estimate the user's emotional state, dynamically generate optimized notifications using a generative artificial intelligence model, and utilize emotional data acquired by a biometric measurement terminal to control the operation of the autonomous control apparatus. This enables real-time adaptive interaction between the apparatus and the user, responsive to user emotions, risk-optimized actions, and dynamically tailored communicative notifications, thereby significantly enhancing user experience and operational safety.

The term “autonomous control apparatus” refers to an automated machine or device capable of collecting information from its surroundings and performing operations independently based on that information.

The term “operational status information” refers to data representing the current state or condition of an autonomous control apparatus, including but not limited to location information, sensor readings, motion states, and environmental data.

The term “information conversion processing” refers to procedures performed to convert raw operational status information into a format suitable for subsequent analysis or processing, such as noise reduction, normalization, feature extraction, and interpolation.

The term “future operation estimation” refers to the process of predicting future actions or behaviors of an autonomous control apparatus based on current and past operational status information.

The term “risk evaluation processing” refers to the assessment of the predicted future operation of an autonomous control apparatus to determine the likelihood and magnitude of potential hazards or adverse events.

The term “alert information” refers to notification or warning data generated in response to a risk evaluation, intended to inform a user about conditions that may require attention or intervention.

The term “user” refers to an individual who interacts with or is affected by the actions of the autonomous control apparatus and receives notifications provided by the system.

The term “emotion estimation processing apparatus” refers to a processing unit, device, software, or algorithm configured to analyze data such as voice, facial expressions, and physiological signals to determine or estimate the emotional state of a user.

The term “emotional state” refers to a psychological and physiological condition of a user, including but not limited to emotions such as happiness, sadness, anxiety, or confusion.

The term “generative artificial intelligence model” refers to a computational model, such as a language model, trained to produce human-like language or other output, capable of generating notification sentences dynamically in accordance with contextual information and user emotional state.

The term “notification method” refers to a manner or modality by which information, such as alert information or guidance, is communicated to a user, including but not limited to text, speech, or visual display format.

The term “optimized notification sentence” refers to a message generated and tailored by the generative artificial intelligence model to best suit the detected emotional state and context of the user, aiming to improve clarity, empathy, and user engagement.

The term “biometric measurement terminal” refers to a device or apparatus configured to acquire biometric data from a user, such as facial images, voice recordings, or physiological parameters, for analysis by the system.

The term “feedback to control the operation” refers to the process by which acquired user emotional data is used to influence, direct, or modify the subsequent actions or behavior of the autonomous control apparatus.

One embodiment for implementing the invention described in the appended claims is set forth below.

The server comprises a processor configured to communicate with an autonomous control apparatus and with one or more user biometric measurement terminals. The autonomous control apparatus may include, as a non-limiting example, a robot or an automated machine equipped with various sensors such as position sensors, cameras, and microphones. The user biometric measurement terminal may be a smart glass, wearable device, or portable communication terminal equipped with a camera and microphone.

The server is configured to acquire operational status information from the autonomous control apparatus via a network such as Wi-Fi or wired LAN. The received operational status information may include real-time position data, video images, and sensor output data. The server uses software tools, such as Python with libraries like pandas for data cleaning and OpenCV for image processing, to execute information conversion processing. For example, the server may remove noise from images using OpenCV’s filtering features, interpolate missing values with pandas, and extract features, such as detecting the presence or absence of people, their positions, and gestures.

Subsequently, the server utilizes a machine learning framework, such as TensorFlow, to estimate the future operation of the autonomous control apparatus. The feature vectors obtained through preprocessing are supplied to the trained model, which predicts the next behavior of the apparatus, such as moving towards a user, stopping, or initiating a communication sequence.

The server then performs risk evaluation processing using either a rule-based algorithm or a trained risk assessment model. For instance, the server may calculate a risk score based on proximity to the user, environmental hazards, or the predicted emotional state of the user. If the risk evaluation indicates a danger or high risk (for example, if the robot is predicted to interrupt a user who appears confused), the server generates alert information.

To optimize the manner in which users are notified, the server also estimates the emotional state of the user. The server receives audio and video data from the biometric measurement terminal. Emotion estimation processing is performed using software such as OpenFace for facial emotion recognition and pre-trained acoustic emotion classifiers for voice analysis. Based on these analyses, the user’s emotional state is classified as “confused,” “anxious,” “neutral,” etc.

Based on both the alert information and the user’s detected emotional state, the server dynamically generates a tailored notification message using a generative artificial intelligence model such as a large language model. This model, for example, may be implemented with a cloud language generation API. The server constructs a prompt sentence that incorporates the context and emotion, and submits it to the generative AI model. An example prompt sentence is:

"The customer appears confused. Please generate a polite, gentle response suitable for a robot assisting the customer, respecting their autonomy."

The generative AI model returns a notification such as:

"May I help you with your order? Please let me know if you have any questions."

The user biometric measurement terminal then presents the notification to the user via its display or speakers, making use of voice synthesis software if necessary.

The user interacts normally, with the system dynamically adapting the behavior of the autonomous control apparatus based on real-time input of both environmental data and ongoing emotion recognition. For example, if a customer in a cafe is unsure how to place an order and appears confused, the system detects this state, evaluates the risk, and ensures the robot approaches with an appropriate, gentle offer of assistance as generated by the generative AI model prompt.

All hardware and software employed—such as a general-purpose server computer, database system, Python, pandas, OpenCV, TensorFlow, OpenFace, wearable terminals with biometric sensors, and a generative language AI model API—are well-known and commercially available. This implementation ensures that the interaction provided by the autonomous control apparatus is dynamically tailored to the user’s emotional condition, thereby improving user satisfaction and operational safety.

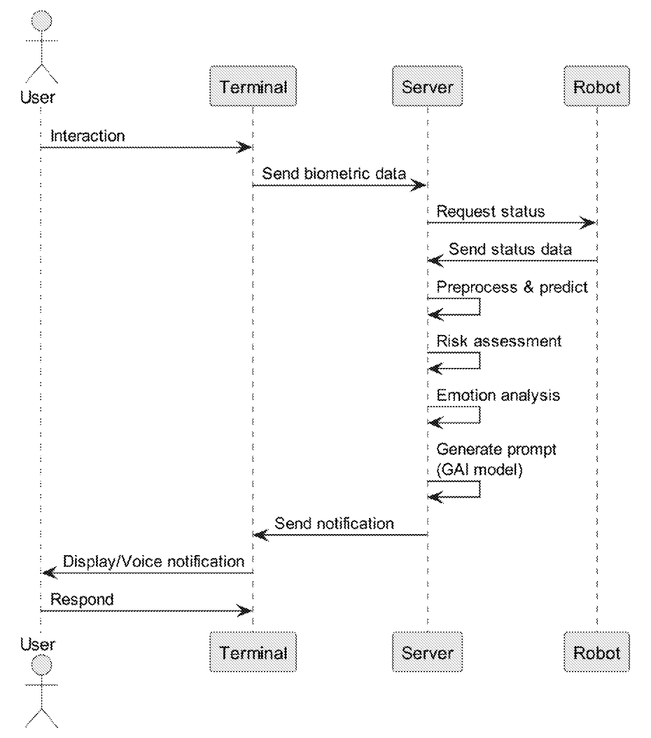

The following describes the processing flow using FIG. 14.

### Step 1:

Server acquires operational status information from the autonomous control apparatus.

Input: Real-time data such as position information, sensor values, and image data from the autonomous control apparatus.

Server receives this data via a network interface and stores it in a temporary database for processing.

Output: Stored raw operational status information.

### Step 2:

Server executes information conversion processing on the acquired operational status information.

Input: Raw operational status information from Step 1.

Server removes noise from images using image processing software (for example, OpenCV), interpolates missing sensor data with data processing libraries (such as pandas), and extracts key features (such as user presence or movement) from the data.

Output: Preprocessed and feature-extracted operational data.

### Step 3:

Server estimates the future operation of the autonomous control apparatus based on the preprocessed data.

Input: Preprocessed and feature-extracted operational data from Step 2.

Server supplies these features to a machine learning model (for example, built with TensorFlow) to predict the next actions, like moving toward a user or pausing.

Output: Predicted future operation or action label.

### Step 4:

Server performs risk evaluation processing based on the predicted future operation.

Input: Predicted future operation from Step 3 and contextual data (such as user proximity or environmental hazards).

Server compares expected actions against predefined safety criteria, calculates a risk score, and determines whether intervention is needed.

Output: Risk evaluation result including a risk score and related details.

### Step 5:

Server generates alert information when the risk score indicates high risk or when specific risk conditions are met.

Input: Risk evaluation result from Step 4.

Server creates an alert message detailing the potential problem and suggested actions, such as advising caution or recommending intervention.

Output: Alert information for user notification.

### Step 6:

Terminal captures biometric information such as user facial expressions and voice data.

Input: Live interaction between the user and the autonomous control apparatus.

Terminal records a short video and ambient audio using its built-in camera and microphone, then transmits the biometric data to the server.

Output: Biometric data including video and voice samples.

### Step 7:

Server analyzes the biometric data to estimate the emotional state of the user.

Input: Biometric data from Step 6.

Server processes video using facial analysis software (such as OpenFace) and audio using a speech emotion classifier, and classifies the user’s emotional state (for example, “confused” or “anxious”).

Output: Estimated emotional state label.

### Step 8:

Server generates an optimized notification sentence using a generative AI model, based on both the alert information and estimated emotional state.

Input: Alert information from Step 5 and emotional state from Step 7.

Server constructs a context-specific prompt (for example: "The customer appears confused. Please generate a polite, gentle response suitable for a robot assisting the customer, respecting their autonomy."), submits the prompt to a generative AI model, and receives a tailored notification sentence (such as: "May I help you with your order? Please let me know if you have any questions.").

Output: Optimized notification sentence.

### Step 9:

Terminal notifies the user of the optimized notification sentence.

Input: Optimized notification sentence from Step 8.

Terminal displays the notification on its screen or uses a text-to-speech engine to provide an audio notification to the user.

Output: User receives the notification in an appropriate format.

### Step 10:

User responds to or interacts with the notification or the autonomous control apparatus.

Input: Notified message and contextual interaction with the autonomous control apparatus.

User may, for example, indicate a need for assistance or provide other feedback through speech or gesture, which is again captured by the terminal for further processing.

Output: User’s response or feedback for continued system operation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

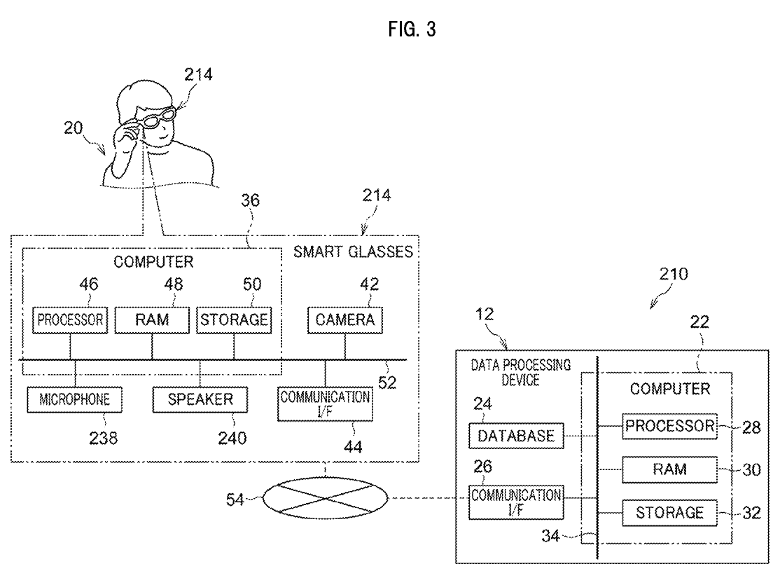

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

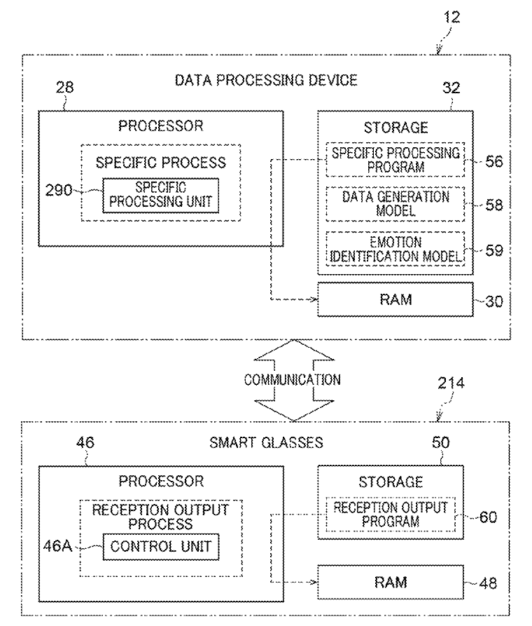

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

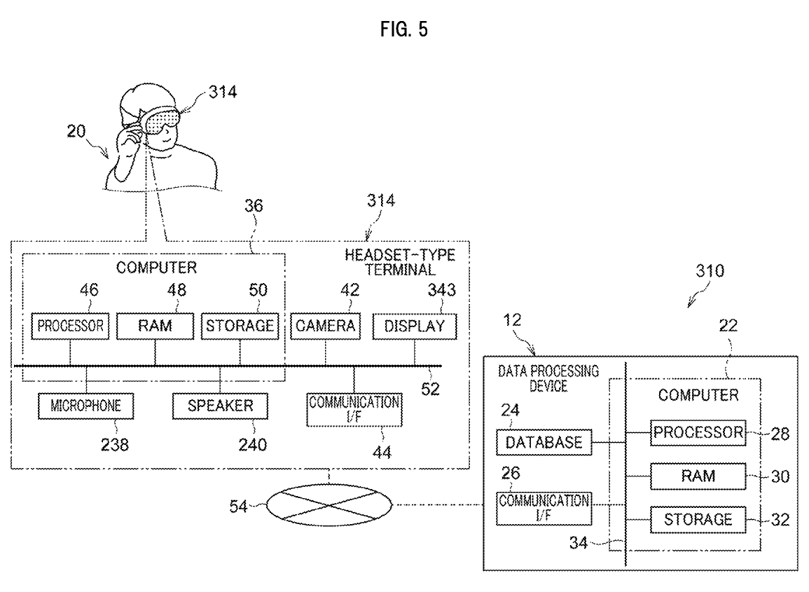

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

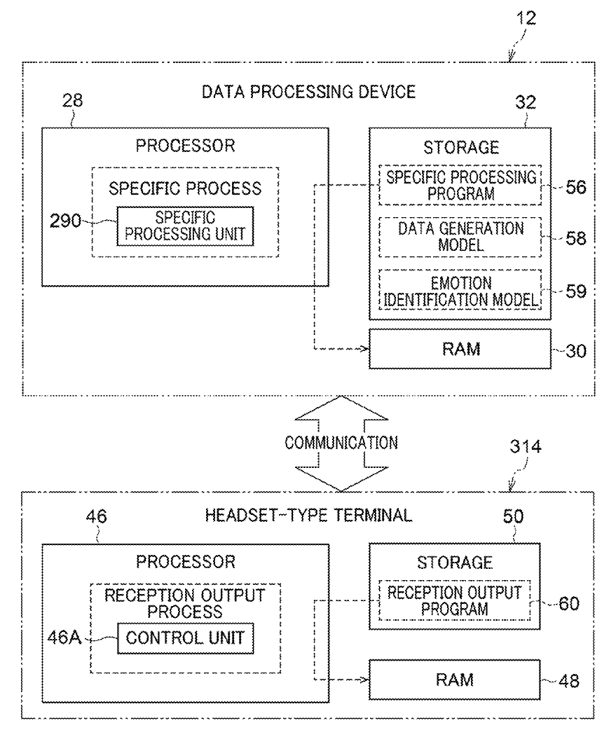

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

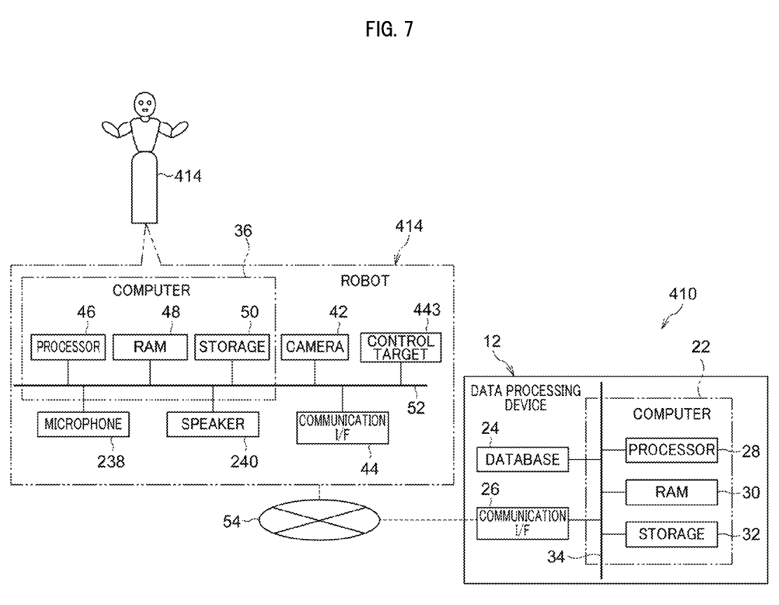

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

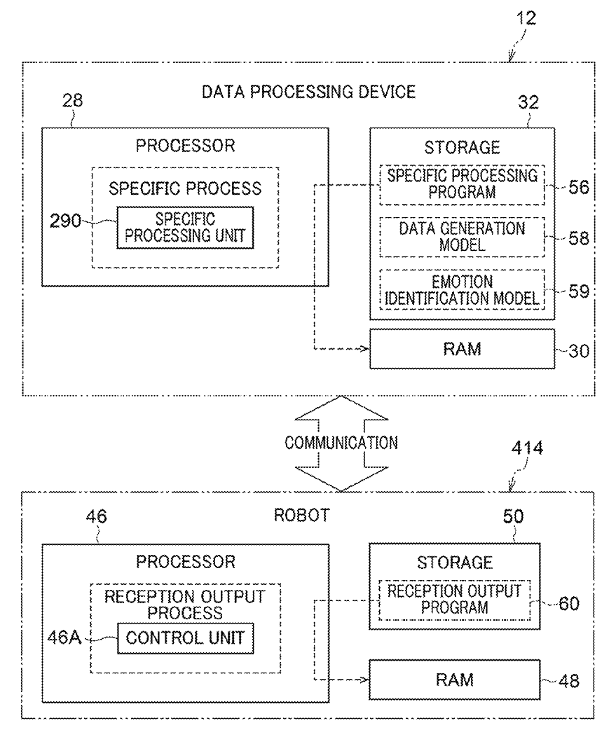

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

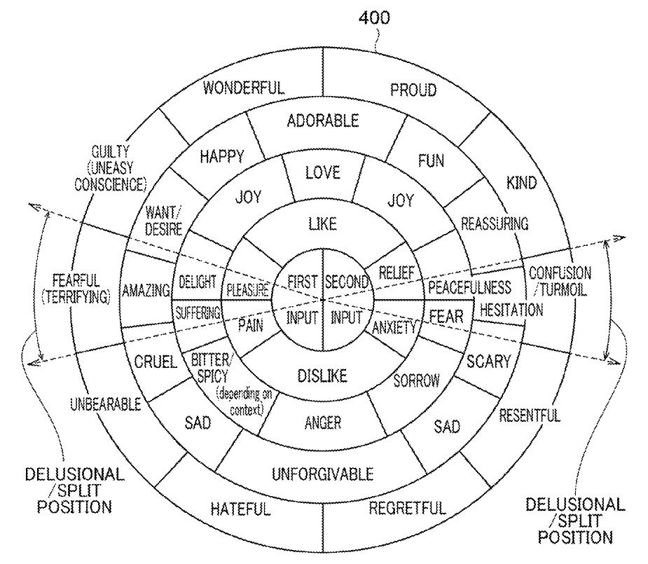

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

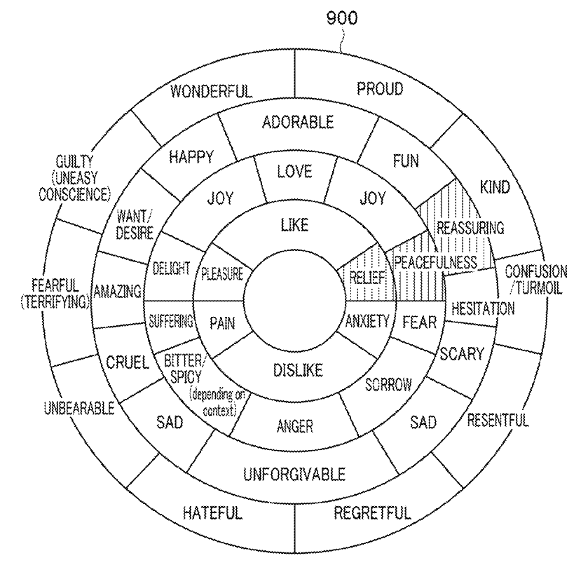

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

collect operation information in a time series from a machine device in real time,

perform preprocessing including noise removal and normalization on the collected operation information by using a data processing device,

input the preprocessed time-series data to a generative artificial intelligence model to predict future operations of the machine device,

generate a prompt sentence for the generative artificial intelligence model to improve prediction accuracy,

evaluate risk by referencing predetermined safety standards for a plurality of operational states based on the predicted future operation information and calculate a risk score,

generate an alert notification including risk information and recommended actions when the calculated risk score exceeds a threshold value, and

notify a user of the generated alert notification via a display device.

### Supplementary 2

The system according to supplementary 1,

wherein the processor is configured to

input a plurality of time-series operation information and environmental information to the generative artificial intelligence model for the purpose of predicting future operations.

### Supplementary 3

The system according to supplementary 1,

wherein the processor is configured to

numerically evaluate whether the predicted future operation exceeds the predetermined safety standard and compute the risk score during risk assessment.

### Application Example 1

### Supplementary 1

A system comprising a processor,

wherein the processor is configured to

collect real-time data including time-series operational information from industrial machinery equipment;

preprocess the collected time-series operational information by removing noise and performing normalization;

input the preprocessed time-series operational information into a trained generative artificial intelligence model, and predict multiple future operational patterns and respective probability values for the industrial machinery equipment;

compare the predicted multiple operational patterns with factory safety standards, calculate risk scores for the respective predicted operations, and perform risk assessment;

generate alert information including details of the risk and recommended response actions when the risk score exceeds a predetermined threshold;

transmit the generated alert information to an information processing terminal and perform display, warning, or operation instruction;

acquire an operator’s voice information or image information using the information processing terminal, and estimate the operator's emotional state using an emotion recognition model;

and adjust the content and method of presenting the alert information in accordance with the estimated emotional state.

### Supplementary 2

The system according to supplementary 1,

wherein the processor is configured to

perform control of the behavior of the generative artificial intelligence model during operational prediction by inputting a prompt sentence for expanding the training data or improving prediction accuracy.

### Supplementary 3

The system according to supplementary 1,

wherein the processor is configured to

receive and record operator response actions to the generated alert information and provide feedback to the control system of the industrial machinery equipment.

### Example 2

### Supplementary 1

A system comprising a processor,

wherein the processor is configured to

collect present information including time-series information from an operation device,

perform preprocessing on the collected present information, the preprocessing including noise removal, missing value completion, and format conversion,

input the preprocessed time-series information to a generative information processing model to estimate future actions of the operation device,

compare the estimated future actions with surrounding environment information and predetermined safety standards to calculate a risk level indicator,

generate an alert when the risk level indicator exceeds a threshold, and adjust the alert content and output method based on user biometric information,

notify the adjusted alert to a display device and cause the display device to output the alert as at least one of a visual output or an audio output,

and analyze user image information and audio information to estimate a user emotional state.

### Supplementary 2

The system according to supplementary 1,

wherein the processor is configured to use the time-series information as input to the generative information processing model and utilize the inference result for future action estimation.

### Supplementary 3

The system according to supplementary 1,

wherein the processor is configured to perform risk indicator calculation to quantitatively evaluate the amount of excess relative to the predetermined safety standards regarding the estimated future actions.

### Application Example 2

### Supplementary 1

A system comprising a processor,

wherein the processor is configured to

acquire operational status information from an autonomous control apparatus,

execute information conversion processing on the acquired operational status information,

estimate a future operation of the autonomous control apparatus based on the information-converted operational status information,

perform risk evaluation processing based on the estimated future operation,

generate alert information based on a result of the risk evaluation processing,

notify a user of the alert information,

estimate an emotional state of the user using an emotion estimation processing apparatus,

dynamically adjust a notification method and generate an optimized notification sentence by using a generative artificial intelligence model based on the estimated emotional state and the alert information,

acquire emotional data by a biometric measurement terminal of the user and feedback the acquired emotional data to control the operation of the autonomous control apparatus.

### Supplementary 2

The system according to supplementary 1,

wherein the processor is configured to

use time series operational status information to estimate the future operation of the autonomous control apparatus.

### Supplementary 3

The system according to supplementary 1,

wherein the processor is configured to

calculate a risk index when the estimated future operation exceeds a safety standard in the risk evaluation processing.

What is claimed is:

1. A system comprising a processor,
wherein the processor is configured to:
collect real-time data from a robot;
preprocess the collected data;
predict future behavior of the robot using the preprocessed data;
perform risk assessment based on the predicted behavior;
generate an alert based on the result of the risk assessment; and
notify a user of the generated alert.

2. The system of claim 1, wherein the processor is configured to use time-series data to predict the future behavior of the robot.

3. The system of claim 1, wherein the processor is configured to calculate a risk score when the predicted behavior exceeds a safety standard in the risk assessment.
